(19) United States
(12) Patent Application Publication
(10) Pub. No.: US 2003/0197428 A1
(43) Pub. Date: Oct. 23, 2003

(54) Power processor

(76) Inventors: Thomas E. Hatton, Manassas, VA (US); Meade G. Bierly, Elizabethtown, PA (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/405,496

(22) Filed: Apr. 3, 2003

Related U.S. Application Data
(60) Provisional application No. 60/369,761, filed on Apr. 5, 2002.

(51) Int. Cl. H02J 7/00

(52) U.S. Cl. 307/82; 307/66

(57) ABSTRACT

An uninterruptible power supply (UPS) provides DC output power and uses a plurality of relatively low power DC/DC converters which are of much higher efficiency and lower heat dissipation than inverters normally used in UPS devices to provide AC output power. Power is stored at high voltage in capacitors to provide output power when input power may be interrupted. Since the power dissipation is reduced and use of batteries can be avoided where redundant input power sources are available, the UPS made be made very compact and of light weight as is particularly suited to mobile machinery such as aircraft, water-borne vehicles and the like.

### CROSS-REFERENCE TO RELATED APPLICATIONS

This application claims benefit of priority of U.S. Provisional Patent Application No. 60/369,761 filed Apr. 5, 2002; which application is hereby fully incorporated by reference.

### BACKGROUND OF THE INVENTION

1. Field of the Invention

The present invention generally relates to electrical power supplies and, more particularly, to compact uninterruptible power supplies particularly useful in complex mobile systems such as aircraft and water-borne vessels.

2. Description of the Prior Art

The generation of electrical power generally requires the conversion of energy which is stored either mechanically or chemically, as in fossil or nuclear fuels or storage batteries and therefore generally requires apparatus of substantial size in order to generate significant amounts of electrical power. Such apparatus, of course, is inherently subject to failure while the use of computers and other sophisticated electronic apparatus which are subject to malfunction or damage from momentary interruptions or fluctuation of power is increasing.

Mobile installations of electronics present a particularly critical environment as processors for such applications as navigation and avionics become more widespread. However, even static installations such as computers in offices present severe requirements for uninterrupted power and the use of back-up systems such as diesel powered generators and so-called uninterruptible power supplies are being installed with increasing frequency to answer this need.

However, while known uninterruptible power supplies (UPS) are highly reliable for providing continuous power, most units in use for protection of computers are of limited capacity and provide only a few minutes of power to allow a back-up generator to be brought on line or the system to be shut down, if necessary, without loss or corruption of data. Further, UPS devices are generally heavy due to the inclusion of rechargeable batteries and are of relatively low efficiency, generally in the range of 70% to 80%, thus dissipating significant quantities of heat, particularly due to the conversion process of converting DC, required for battery back-up, back to AC. That is, the low efficiency of UPS devices is principally due to the use of inverters to supply alternating current power similar to commercially available power provided by public utilities. These shortcomings are often tolerable for static installations with low density of UPS device installations. However, they present further and severe problems in mobile installations where high density UPS installation is not generally practical due to a combination of size, weight and heat dissipation. Further, conventional UPS devices cannot be ganged together with a common output bus to provide additional power supply capacity and/or redundancy without complex synchronization arrangements or output switching which, in any event, cannot be provided instantaneously.

Systems with larger power requirements generally utilize other forms of redundancy that are usually much less capable of avoiding at least momentary interruptions and fluctuations of power. For example, diesel generators alluded to above generally require several seconds to be brought on line since the diesel engine power source is not started until a power interruption is detected. Mobile systems with continuously running generators may use plural, redundant power busses between which a load can be switched to provide power from a redundant power bus when an interruption in a given power bus is detected. However, even in such a case, the switching may require several tens of milliseconds (e.g. seventy milliseconds for mechanical switches generally used at present) which is sufficiently long to cause malfunction and/or damage to many commercially available (e.g. commercial off-the-shelf or COTS) processors and other devices. Processors running UNIX or LINUX, as is increasingly common in larger systems, have been found susceptible to malfunction or damage by momentary interruptions of power.

Additionally, the power requirements for mobile systems is often highly variable and may be very different in different installations. While installation-specific power supplies could be designed, it is often not practical to do so since original design work is costly and equipment made in small numbers is relatively more costly to manufacture and maintain. Further, known UPS device designs are generally scalable over only a relatively narrow range of power capacities and then often only at the expense of reduced efficiency.

In summary, the reliability of a wide variety of electronic equipment is often limited by the reliability of the power supply which can be provided and which is often compromised by the environment in which the equipment and power supply is to operate. Known, commercially available UPS devices are of low electrical and spatial efficiency and produce substantial amounts of heat which must be dissipated, often in environments in which heat dissipation is difficult. For example, air conditioning, fluid cooling or the like requires significant amounts of additional power and effectively further reduces efficiency of the overall installation and will often be required due to space limitations in environments where power availability is at a premium.

Power factor correction (PFC) and protection of equipment from line perturbations and transient conditions which may occur in the operational environment such as electromagnetic interference attenuation to meet military and government limits is also required. Reduction of electromagnetic interference effects as well as limitations on available space cause high density of power conversion equipment while achievement of high density is generally limited or seriously compromised by heat dissipation requirements. At the same time susceptibility to electromagnetic interference also generally increases with power supply density (e.g. peak rated power per unit volume). Input to output isolation must also be provided for most applications.

### SUMMARY OF THE INVENTION

It is therefore an object of the present invention to provide a power supply architecture which provides increased efficiency and reduced heat output, increased quality of electrical power and reduced size of power conversion equipment in a convenient and dense configuration particularly for applications to mobile machines.

It is another object of the invention to provide a power supply which can provide a wide range of voltages efficiently with an easily maintained modular articulation which provides scalability over a wide range and enhanced reliability through increased redundancy.

It is a further object of the invention to provide an uninterruptible power supply architecture as a power processor which is compatible with the provision of protection from environmental conditions such as EMI interference and emissions.

It is yet another object of the invention to support reliable operation of commercial off-the-shelf electronic equipment as well as specially built electronic equipment in severe environments.

In order to accomplish these and other objects of the invention, a power processor having the function of an uninterruptible power supply is provided including a plurality of relatively low power but scalable, high efficiency DC/DC converters in each of a plurality of converter modules to provide N+1 redundancy, each having one or more capacitors for power storage at a relatively high voltage preferably at least twice that of the output of the DC/DC converters in order to increase power storage. Battery back-up power can be provided to increase the time power output is maintained without input power, if needed or desired. Active power factor correction and electromagnetic interference filtering is preferably provided in common for all converter modules which, due to the high efficiency and low heat dissipation of the DC/DC converters, can be packaged in a dense, compact form in a housing adaptable for standard rack mounting. An output bus common to some or all of the converter modules provides graceful degradation and smooth shifting of load between converter modules and between phases of input power without need for additional control when one or more converter modules fail. DC Power is provided to processors and other types of electrical equipment and the loss of efficiency required in re-conversion to AC power is thus avoided; allowing the dense and compact packaging and avoidance of more complex and energy-consuming forms of heat removal.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a perspective view of a preferred packaging of a power processor in accordance with the invention,

FIG. 2 is a high-level block diagram of the architecture of the power processor architecture invention,

FIGS. 3 and 4 are schematic depictions of the preferred internal layout of the power processor and a module thereof, respectively, and

FIG. 5 is a schematic diagram of a connection of a back-up battery and charger which may be employed with the invention as a perfecting feature thereof for some applications.

### DETAILED DESCRIPTION OF A PREFERRED EMBODIMENT OF THE INVENTION

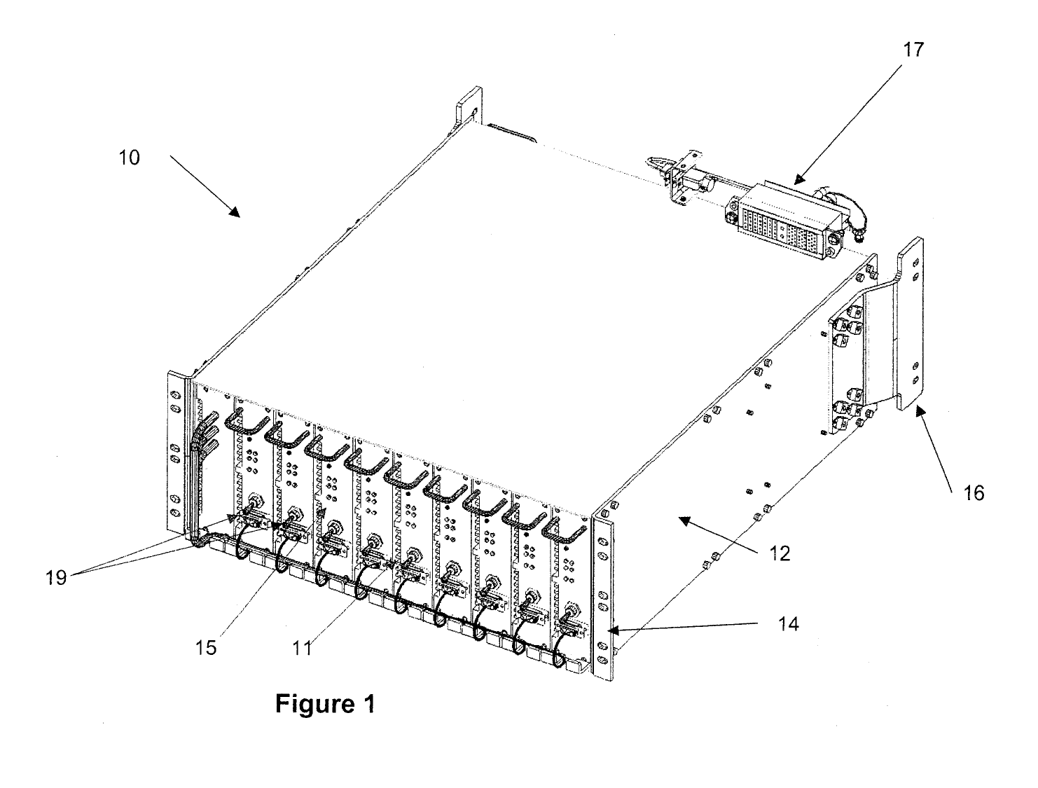

Referring now to the drawings, and more particularly to FIG. 1, there is shown, in perspective view, a preferred physical form of the power processor 10 in accordance with the invention. This embodiment of the invention is intended to have a nominal power supply capacity of 6.0 KiloWatts (kW) and a maximum power supply capacity of 9.0 kW at a DC output voltage of one hundred fifty volts. Preferably, in view of the projected applications of the invention in mobile machines, the power processor is packaged in hardware suitable for standard rack mounting which advantageously provides for convenient and standardized cooling arrangements as will be discussed in greater detail below. However, neither the packaging nor the details of the cooling arrangement is critical to the successful practice of the invention. Electrical connections such as output connections 17, module input power via 19 or connections on the rear of the housing 12 can be made at either the front or back side of the power processor 10 as may be convenient.

As shown in FIG. 1, the basic housing 12 is provided with brackets 14 and mounting holes 16 which are adapted to be securely attached to vertical portions of a standard rack mount. As is familiar to those skilled in the art, standard rack mounts have vertical portions with threaded holes which are supported at a horizontal spacing of either nineteen inches or twenty-four inches. The threaded holes are spaced on three-quarter inch centers along the vertical portions and housings 12 or panels are sized in multiples of standard rack units (U) of approximately one and three-quarters inches. In the embodiment shown, housing 12 preferably has a height of 6.96 inches or 4U. The housing is also arranged to hold nine AC/DC converter modules 15 and an additional module 18 which will be described in greater detail below. Therefore, it can be seen that the invention provides a very compact and dense installation of the converter modules 15 each of which preferably has a power supply capacity of one kW. This compact and dense configuration allows more processors and other equipment to be provided with the power processor in accordance with the invention in a given amount of rack space.

Since nine converter modules 15 are provided and the rated maximum power is 6.0 kW, the maximum rated power can be delivered even if several of the converter modules 15 become inoperative. (The modules may be individually controlled by switches 11 if less power is required.) Conversely, with all converter modules operating, peak loads 150% of maximum rated power can be accommodated. This type of additional capacity and redundancy provides a highly reliable power source and is sometimes referred to as “sparing” (in the sense of effectively providing spare modules) or “N+1 redundancy” and, upon failure of one or more modules, provides reliable continued operation sometimes referred to as “graceful degradation” with the load being smoothly and evenly redistributed among converter modules and across input power phases without the need for any control such as by a computer or adaptive circuitry that would effectively further reduce efficiency and consume space. The power processor in accordance with the invention may be regarded as being entirely analog in operation and supplies power as required without any need for condition responsive control.

The efficiency of the converter modules 15 in accordance with the invention is about 90% to 95% using known designs and thus sufficient cooling (three hundred to six hundred Watts at maximum rated power) is readily provided even though the modules are densely packed. By way of comparison, a COTS UPS device of comparable power supply capacity would require 9U (15.75 inches) of rack mounting space and require heat dissipation of 1.2 kW or more; two to four times that of the invention and would not provide internal redundancy and enhanced reliability, as provided by the invention.

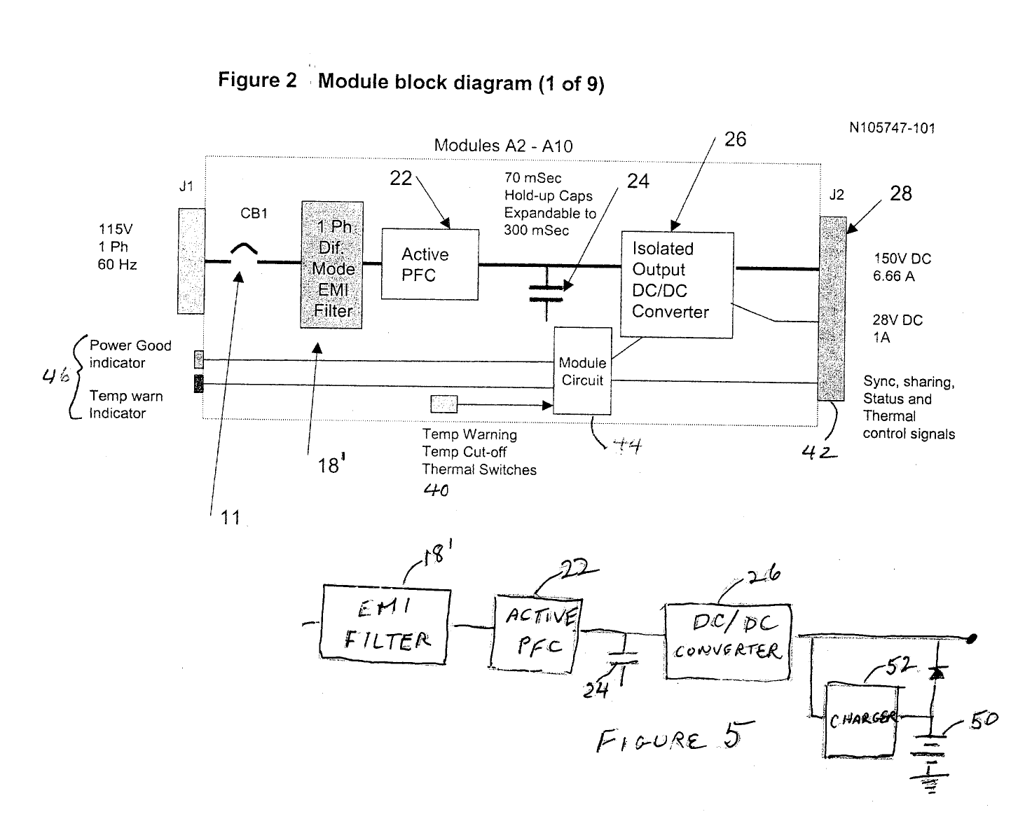

Referring now to FIG. 2, the architecture of the power processor 10 in its preferred environment will be discussed. The nine converter modules 15 are depicted as grouped in groups of three, as is considered to be preferable in view of preferable configurations of circuit breakers (e.g. three three-pole 20A circuit breakers although a three-pole 60A circuit breaker could also be used) to supply power to the power processor. The preferred grouping also serves to distribute the load over the preferred three phases of input power.

Each module is comprised of an active power factor correction (PFC) circuit 22 to avoid ripple currents from being reflected to the input power source line in compliance with current standards, a hold-up capacitor 24 and a DC/DC converter 26 connected to a common DC output bus 28. The additional module 18 is preferably comprised of an input protection circuit 23 such as an electromagnetic interference (EMI) filter and main on/off controls and fault monitoring circuits 25 as well as a voltage step-up transformer (a 120 volt, three phase power input is assumed and preferred but any other form of power input can be readily accommodated, as will be evident to those skilled in the art) and the like to provide the desired operating voltage. Internal protection circuits such as a thermal sensor 40, current sharing and status control circuits 42, control circuits 44 and status indicators 46 may be provided, if desired, and, if provided, are preferably provided for individual converter modules rather than commonly for all converter modules.

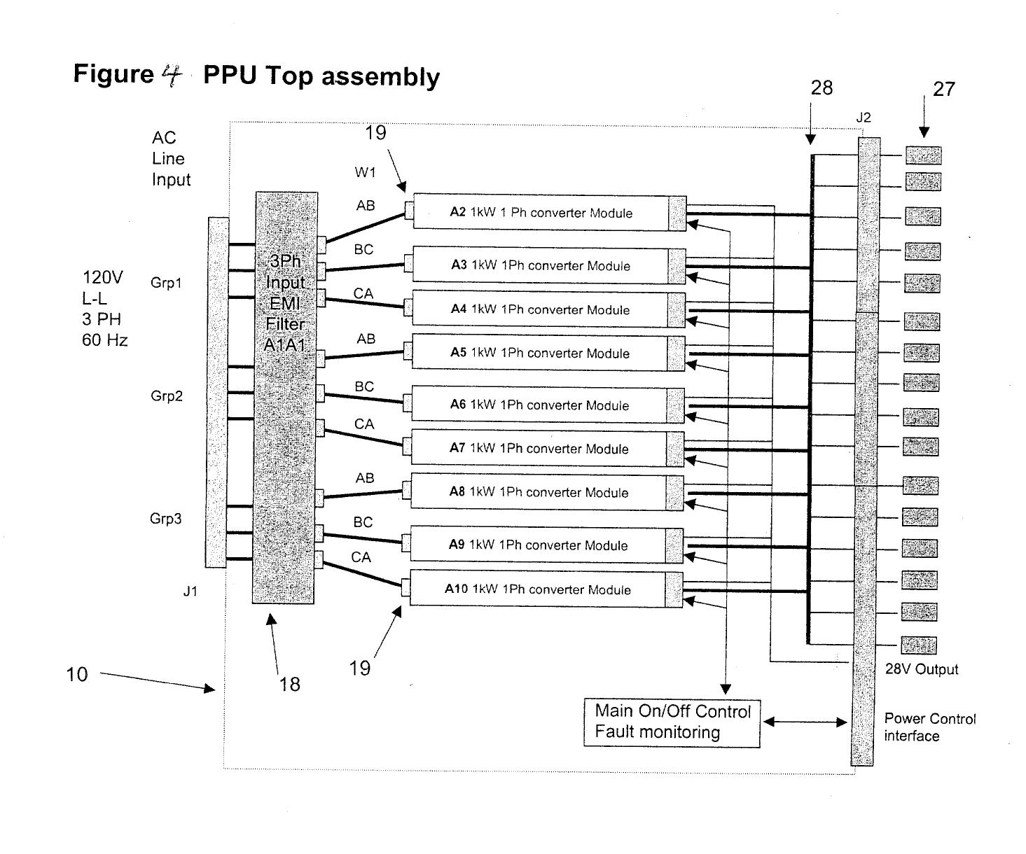

The details of design of these basic elements of modules 15 and 18 are not critical to the practice of the invention and suitable devices are known and commercially available. It is, however, preferred that the hold-up capacitor(s) be chosen to have a capacitance and be operated at a voltage which will provide uninterrupted power for a desired duration such as the period for switching between power supply busses (e.g. 70 milliseconds for mechanical switches commonly employed). For that reason the hold-up capacitor(s) store power at a voltage preferably greater than twice the output voltage of the DC/DC converter. As schematically illustrated in FIG. 5, a back-up battery 50 and charger 52, preferably operating at the output voltage of the DC/DC converters, can be employed much in the manner of known UPS devices if only a single power bus is available but is not otherwise considered to be desirable since a battery would require significant additional volume and weight. For this reason, it is considered preferable in view of sizes, capacitances and cost of commercially available components to operate the hold-up capacitors at about three hundred eighty volts (e.g. to keep the sum of nominal operating voltage and the ripple voltage under four hundred volts). Higher voltage capacitor dielectric strengths may require larger capacitor sizes and may be more costly while, conversely, lower voltages may also require larger capacitor sizes to accommodate larger capacitor plates, while computer grade capacitors rated at four hundred volts are readily and economically available having suitable capacitance values and overall sizes. It is also preferred but not critical to the practice of the invention to use a plurality of individual capacitors connected in parallel as the hold-up capacitor 24 in each converter unit in order to increase redundancy and to better accommodate the geometry of the capacitors within the converter modules. In this regard, it is preferred to configure the converter modules 15 such that additional capacitors may be added to tailor the hold-up time to the requirements of a particular installation (e.g. up to or exceeding 300 milliseconds). An output voltage of DC/DC converter modules 26 of one hundred fifty volts (corresponding to rectified 120 volts AC to allow direct powering of active PFC servers) is preferred but not critical to the practice of the invention as the design of DC/DC converters for any combination of input and output voltages is well-understood in the art. Other DC output voltages can be realized to accommodate other user load voltages (e.g. 48 volts).

Otherwise, it is a basic principle of the invention to provide an architecture allowing the use of a plurality of relatively low power PFC and DC/DC converter modules which are readily available and/or economical to manufacture and having high efficiency to allow dense packing while achieving the additional benefit of increased reliability engendered by a high degree of redundancy. That is, using DC/DC converters to supply DC power may be much more efficient than using an inverter to supply AC power and thus the invention exploits this difference in efficiency by using a plurality of relatively low power modules which may be densely packed by virtue of their higher efficiency and lower power dissipation to provide an uninterruptible DC power supply having high reliability and high electrical power quality due to its internal redundancy. Integral to this approach is input to output isolation. Since the input power is not necessarily ground referenced (e.g. if the preferred three phase AC power source is provided) and therefore such isolation is required and provided by the DC/DC converter, as is known in conventional designs thereof. Such isolation allows the negative or return side of the DC power circuit to be ground referenced.

A further form of input to output isolation is provided by the electromagnetic interference (EMI) filter 18′ as well as by the filtering function provided by the hold-up capacitors 24 and an output filter, if provided, as is preferred. As alluded to above, the problem of propagation of electromagnetic interference through the power modules and to the load becomes more severe as density of the power supply arrangement is increased. The invention has been found to adequately avoid such propagation of electromagnetic interference by filtering the input power and limiting or eliminating internal generation of EMI by the filtering action of the hold-up capacitors with or without output filtering.

The common output bus 28 connects some or all outputs of DC/DC converters 26 and feeds an external power bus 30 that may be articulated or divided as desired to provide an input to external on/off controls and fault monitoring circuits 27 which may also include circuits to step down the voltage on common bus 30 to the voltages needed by powered circuits 29 which can be configured as fifteen 400W dual outputs or thirty 200W individual outputs. Output filtering can also be provided, if desired, either in the individual power circuits, on the common output bus 30 or, preferably, in the converter modules 15.

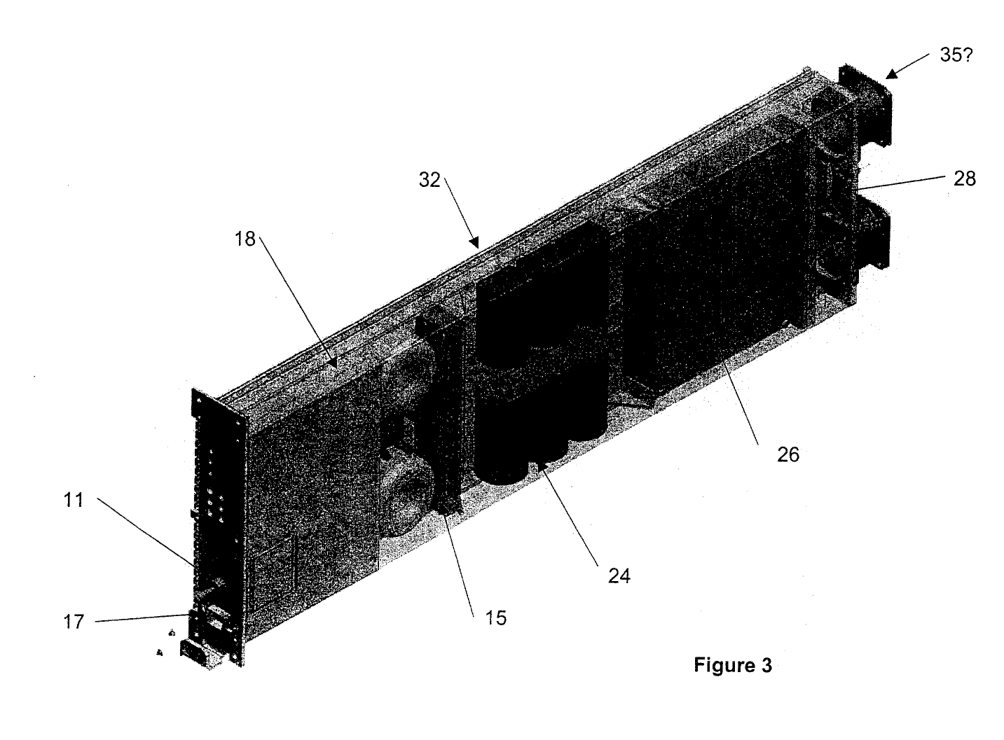

A perspective, semi-transparent view of a preferred physical layout of a converter module is illustrated in FIG. 3. As illustrated, the front of the power processor is oriented toward the left side of the drawing. It should be appreciated that a common EMI filter 23 can be used for all converter modules 15 of the power processor 10, as shown in FIG. 2, or individual EMI filters may be provided internally to each converter module as depicted at 23′. Alternatively, an EMI filter may be divided between the two locations as may be found convenient and, in any case, is not important to the practice of the invention although provision of an EMI filter is preferred in view of the anticipated applications of the invention. The location shown for internal EMI filter 23′ is preferred since heat dissipation therefrom is negligible. The same is true for the illustrated preferred location(s) of the hold-up capacitors 24.

Preferably, the entire back side (in the view of FIG. 3) of the module is covered by a forced air cooled (FAC) heat sink 32 with the active power factor correction (PFC) circuit 22, output DC/DC converter 26 and, if used, an output filter 34 arranged from front to back (e.g. in the direction of forced air flow). Fans 35 are preferably used to draw air from the front of the housing 12 and exhaust air at the back. In general, the dissipation from the PFC circuit (which may include a transformer and rectifiers as well as some active components for power factor correction) will be greatest among these components and the illustrated arrangement allows more heat to be transferred since the forced air will be at the lowest temperature at the front or inlet side of the heat sink 32. Connections may be made as desired at the front and/or back of the converter modules 15 as illustrated in FIG. 1.

It should also be appreciated that the module layout illustrated in FIG. 3 allows the module configuration to be somewhat less than 1U thick and less than 4U tall such that nine modules can be placed side-by-side in housing 12 while allowing for an additional 1U location/slot for another module which may be arranged, for example, to provide special voltages other than the voltage provided from the other converter modules, to hold a battery, to hold a charger circuit for an external battery or other possible uses.

Alternatively, the 4U×1U cross-section allows the modules to be arrayed in other arrangements and module orientations in housing 12 (e.g. with the heat sink on the top of bottom of the module). The modules can also be scaled such that a module providing 1 kW to 2 kW could be arranged with a 2U thickness. More than one array of modules can be provided in a single housing 12, as well (e.g. two pows of nine modules each could be provided to supply 12 kW to 14 kW).

Referring now to FIG. 4, a top view of a preferred physical layout of the power processor is illustrated. Front power input source and output connections 19 and rear power output connect 17 and output bus 28 are illustrated in exemplary locations. A common main control circuit board 42 is could be located at the front of the housing 12 to be conveniently available for the provision of manual control switches, indicator lights and/or gauges or the like but is not preferred since such a board would also be a single point of failure for the entire power processor. Instead, a common board may also be configured as a “mother board” for convenience of connection to the individual converter modules 15 and power distribution), as is considered preferable. Exhaust fans 35 providing forced air cooling are located at the rear of the housing 12 but could be provided on the individual modules.

In view of the foregoing, it is seen that the invention provides a compact, dense arrangement of a plurality of converter modules utilizing high efficiency DC/DC converters to provide DC output power of high quality and reliability at an overall efficiency of greater than 90%. Weight and size are reduced by using storage capacitors operating at a high voltage to provide uninterruptible output power when input power may fluctuate or fail for brief periods such as the switching time between power busses by mechanical switches or potentially longer periods. The size of the power processor UPS device in accordance with the invention is reduced by more than half compared to a conventional UPS and weight is also markedly reduced. Further efficiency is also engendered in electrical and electronic equipment powered with the UPS in accordance with the invention since such equipment can be directly powered with DC power and does not require conversion from AC power provided by conventional UPS devices including inverters commonly used to produce AC power.

While the invention has been described in terms of a single preferred embodiment, those skilled in the art will recognize that the invention can be practiced with modification within the spirit and scope of the appended claims.

Having thus described my invention, what I claim as new and desire to secure by Letters Patent is as follows:

1. A power processor comprising
a power input,
a plurality of converter modules, and
an output bus for receiving power from at least two of said plurality of converter modules,
each of said plurality of converter modules comprising
a circuit for producing a DC voltage from power applied at said power input,
a storage capacitor for storing charge at said DC voltage, and
a DC/DC converter for converting said DC voltage to a desired DC voltage.

2. A power processor as recited in claim 1, further comprising
an output filter connected between said DC/DC converter and said output bus.

3. A power processor as recited in claim 1, further including
an electromagnetic interference filter connected to said power input.

4. A power processor as recited in claim 2, further including
an electromagnetic interference filter connected to said power input.

5. A power processor as recited in claim 1, further comprising
a back-up battery power source.

6. A power processor as recited in claim 4, further comprising
a battery charger for said back-up battery power source.

7. A power processor as recited in claim 1, wherein said hold-up capacitor stores power at a voltage greater than twice the output voltage of said DC/DC converter.

8. A power processor as recited in claim 1, further including
an active power factor correcting circuit.

9. A power processor as recited in claim 1, further including
a common board connecting respective ones of said converter modules and including connections for power distribution.

10. A power processor as recited in claim 1, wherein said DC/DC converters produce an output of approximately 150V.

11. A power processor as recited in claim 10, wherein said DC/DC converters produce an additional output voltage different from 150V.

12. A power processor as recited in claim 1, further including
a thermal sensor and a protection arrangement for controlling a said converter module responsive to an output of said thermal sensor.

13. A power processor as recited in claim 1, wherein nine converter modules are located side-by-side in a standard rack mount.

14. An electronic device comprising
a digital circuit, and
a power supply for supplying DC power to said digital circuit, said power supply comprising
a DC/DC converter for supplying power at a first voltage, and
a storage capacitor for storing power at a second DC voltage, said second DC voltage being greater than twice said first voltage.
